(19) United States
(12) Patent Application Publication
(10) Pub. No.: US 2004/0006637 A1
(43) Pub. Date: Jan. 8, 2004

(54) Methods and systems for transmitting application software

(76) Inventors: Pramote Kuacharoen, Trang (TH); Vincent J. Mooney III, Decatur, GA (US); Vijay K. Madisetti, Marietta, GA (US)

Correspondence Address: NORA M. TOCUPS, P.O BOX 698, 140 PINECREST AVE, DECATUR, GA, 30030, US

(21) Appl. No.: 10/423,305

(22) Filed: Apr. 25, 2003

Related U.S. Application Data
(60) Provisional application No. 60/375,887, filed on Apr. 25, 2002.

(51) Int. Cl. G06F 15/16

(52) U.S. Cl. 709/231

(57) ABSTRACT

Methods for minimizing starting run time of application software are presented. Application software may be divided into blocks or components. If divided into blocks, a block may include a block loader function for calling another block having an instruction otherwise not included. Application software is transmitted to a client, which may begin execution as the application software is being transmitted. The client may encounter a block loader function causing the server to transmit the block that includes the instruction. In response to receiving the transmission, the client runs the application software using the instruction. If the application software is divided into components, each component may be encapsulated by a handler. A component may be divided into sub-components. A function included in a sub-component may be dependent upon a function in another sub-component. If the function is called, then the function(s) dependent upon the called function are transmitted to the client.

### RELATED APPLICATION

This application claims priority to and the benefit of the prior filed co-pending and commonly owned provisional patent application, which has been assigned U.S. Patent Application Serial No. 60/375,887, entitled “Embedded Software Streaming,” filed on Apr. 25, 2002, and incorporated herein by this reference.

### FIELD OF THE INVENTIONS

The inventions relate to the use of application software by computers, and specifically, to the transmission of application software between or among devices operating in or connectable to a computer system.

### BACKGROUND

Hand held and other portable devices such as wireless phones, personal digital assistants (PDAs), game units, and laptop computers are convenient to use at least because of their small size and portability. Similarly, a personal computer (PC) used at home, in the office, at school, or elsewhere is a powerful tool, especially when connected to a global data network such as the Internet, even though the PC is housed in a relatively small set of equipment.

The relative small size of the devices mentioned above make them convenient to use. Such small size, however, has its drawbacks. One of the drawbacks of small size is that only a limited amount of information may be stored by such devices. The amount of information stored by a device generally limits its capabilities. To increase capabilities, a device may be fitted with a larger storage area. Yet, increasing the storage area of a device generally also increases the size of the device, and the bigger the device is, the less convenient it may be to use.

To overcome the problem of small size, efforts have been made to use the storage area of a device as efficiently as possible. For example, a device may store only information that is necessary to the operation of its most commonly used features or capabilities. If an uncommon feature or previously unused capability of the device is invoked by the user, the device may take action to obtain the necessary information from some other source. In addition, the device (at the instigation of the user) may take action to obtain updates to its stored features and capabilities.

To illustrate, a user may direct a PC to execute application software that has not previously been used. In response, the PC may retrieve the application software over the Internet from an appropriate source and carry out the user's instructions.

A problem with having a device retrieve information from another source rather than having stored the information is that the retrieval takes time. The device has to find the source and have the information transmitted. All of the information may have to be transmitted to the device before the device can begin working with the information. The amount of time taken between the time of the user's selection of unavailable information to the time the device can start using the information is referred to as application load time.

Application load time can also be referred to as wait time. Wait time can be frustrating to the user. Wait time interrupts or delays the user's use of the device. Wait time can be a mundane matter such as wait time that causes delay in a user's enjoyment of a new feature of a video game or a chat room session. Wait time assumes more significance when the user is involved in a task such as doing school work, conducting research, or engaging in business matters. Wait time may be of critical significance in situations where decisions need to be made quickly, where communications must be exchanged expeditiously, or where data must be obtained and acted on an urgent basis.

In recognition of the problems associated with wait time, efforts have been made to reduce wait time as much as possible. One way of reducing wait time is to allow for the overlapping transmission of the information and the device's use of the information. With reference to application software, wait time may be reduced by allowing a device to begin execution of the application software even while the application software is being transmitted (also referred to as downloaded) to the device. The overlapping of transmission and execution of application software is referred to as software streaming.

There are drawbacks to software streaming. A drawback is that the complete application software may be streamed to the device when the device only needs certain portions of the application software. In other words, software streaming may result in inefficient use of the storage area of the device.

Another drawback of software streaming is that the application software may be streamed to the device in such a way that does not reflect the order of use of the portions of the application software by the device. If the device requires a certain portion of the application software, but the required portion is not transmitted until late in the streaming process, then the device may be unable to proceed with execution of the application software. In other words, the wait time may not be reduced or not reduced by much if the application software is streamed in an order that fails to reflect the use of the application software by the device.

Accordingly, there is a need for devices that are convenient to use by their relative small size and portability, and that also allow for desired features and capabilities to be made available to the user.

There is a need to maintain the relative small size of such devices by efficient use of their storage areas with respect to the information necessary to allow for desired features and capabilities to be made available to the user.

There is a need to efficiently use the storage areas of such devices allowing the devices to retrieve information from other sources as necessary.

There is a need to reduce the wait time or application load time with respect to the transmission of the information to the device and the device's execution based on the information.

There is a need to overcome the drawbacks of software streaming used to reduce wait time or application load time so as to efficiently use the storage area of the device and to stream the portions of the application software in an order that reflects the use of the application software by the device.

### SUMMARY OF THE INVENTION

The inventions meet the needs described in the background by providing methods and systems that minimize the time it takes to start running application software by allowing a client to begin execution of the application software prior to completion of the download of the application from a server. Advantageously, the inventions allow a client to efficiently use its storage area by streaming portions of the application software in response to use of the application software by the client.

An exemplary embodiment of the inventions is a method that relates to the transmission of application software to a device. The application software may be stream-enabled application information including an application size, a stream-enabled data size, a block placement type, and a maximum number of blocks.

The exemplary method divides the application software into blocks. If the execution of a block requires an instruction not included in the block (also referred to as an “off-block instruction”), the block may be modified by the inclusion of a block loader function for calling a block that includes the instruction.

At least one of the blocks is transmitted to a device, which may start running the application software. The device may set up a block-lookup table having an entry corresponding, respectively, to each of the transmitted blocks. Each entry may include an identifier of a block and an address for the block. Advantageously, the device may start running the application software by using one or more of the transmitted blocks even though all of the blocks of the application software have not been transmitted to the device running the application software.

In running the application software, the device may encounter a block with an off-block instruction including a block loader function. The block loader function may be used to cause transmission of the block that includes the instruction to the device. The application software then may be run using the instruction. In addition, the block including the block loader function may have the block loader function changed into a direction to the block that includes the instruction.

The inventions include another exemplary method that minimizes the time it takes to start running application software by allowing a client to begin execution of the application software prior to completion of download of the application software from a server. The application software may include stream-enabled application such as an application size, a stream-enabled data size, a block placement type, and a maximum number of blocks.

The exemplary method divides the application software into blocks. Each block may be assigned, respectively, linker data and loader data. A block may include an off-block instruction that directs the client to a specific block not in the client's memory. The off-block instruction is modified by including a block loader function that may cause the client to effect transmission of the specific block from the server.

One or more of the blocks are transmitted from the server to a client. In the transmission, the stream-enabled application information may be transmitted first. In response to receiving the stream-enabled application information, the client may set up a block-lookup table having an entry corresponding, respectively, to each of received blocks. Each entry may include an identifier and an address.

In response to receiving one or more blocks, the client loads and links each block in memory and may use a block's linker data and loader data in loading and linking the block into the client's memory. Advantageously, the client begins execution of the application software by using the one or more of the blocks even though not all of the blocks of the application software have been transmitted from the server to the client.

In running the application software, the client may encounter a block having an off-block instruction such as an off-block instruction including a block loader function. The off-block instruction may refer to a specific block. The client may check whether the specific block is stored in the client's memory. If the specific block is stored in the client's memory, then the client may change the off-block instruction by adding a direction to the specific block. The client may delete or otherwise change the block loader function in the block, too.

If the client's check does not find the specific block stored in the client's memory, then the client may cause the specific block to be transmitted from the server. The specific block then may be stored in the client's memory. Further, the client may change or add to the off-block instruction in the block to include a direction to the specific block in the memory.

The inventions also include an exemplary method for minimization of starting run time of application software that divides the application software into components with each component including an interface. Each component is encapsulated by a corresponding component stream-enabling handler, which may be generated from a configuration file associated with the application software. The component stream-enabling handler may be linked to the component at compile time of the application software.

Further, the exemplary method may divide a component into sub-components. For example, a component may be divided into a first sub-component and a second component. The sub-components may include one or more functions of the application software. For example, the first sub-component may include a first function and the second sub-component may include a second function. A function or functions in one of the sub-components may be dependent for operation upon a function or functions in another sub-component or sub-components. For example, the first function of the first sub-component may be dependent upon the second function of the second sub-component.

In the course of running the application software, a need for the first function of the first sub-component may arise. In that case, a call for the first function of the first sub-component of the component is made by using an interface of the component and by using a component stream-enabling handler corresponding to the component.

In response to the call, a determination results in the finding that the first function of the first sub-component depends on the second function of the second sub-component. Because the first function depends on the second function, both the first sub-component and the second sub-component are transmitted in response to the call.

Advantageously, the exemplary methods reduce wait time or application load time by allowing a client to begin execution of the application software as it receives streamed blocks or components of the application software. If the client requires a function in a component or block that has not been streamed to the client, the exemplary methods allow the client to obtain the required functions or instructions without having all of the application software streamed to the client. Moreover, a required function may be transmitted to the client with any other functions upon which it depends. In sum, the exemplary methods reduce wait time during software streaming and allow a client to make efficient use of its storage area without hindering execution of the application software.

### BRIEF DESCRIPTION OF THE DRAWINGS

FIG. 1 illustrates an exemplary environment for operation of the inventions.

FIG. 2 illustrates actions in an example of block streaming.

FIG. 3 also illustrates actions in an example of block streaming.

FIG. 4 is an exemplary logic diagram relating to an example of block streaming.

FIGS. 5a-5b illustrate actions relating to an example of block streaming.

FIGS. 6a-6b also illustrate actions relating to an example of block streaming.

FIG. 7 illustrates an exemplary component relating to an example of component streaming.

FIG. 8 illustrates actions and components relating to an example of component streaming.

FIG. 9 illustrates an exemplary interface table relating to an example of component streaming.

FIG. 10 illustrates a control/data flow graph relating to an exemplary embodiment of the inventions.

### DETAILED DESCRIPTION

The inventions relate to methods and system for transmitting application software such as between a server and a client. Advantageously, the inventions minimize the time it takes to start running application software by allowing a client to begin executing the application software prior to completion of the download of the application software from a server. After a brief description of exemplary environments for operation of the inventions, exemplary embodiments of the inventions referred to as block streaming and component streaming are described.

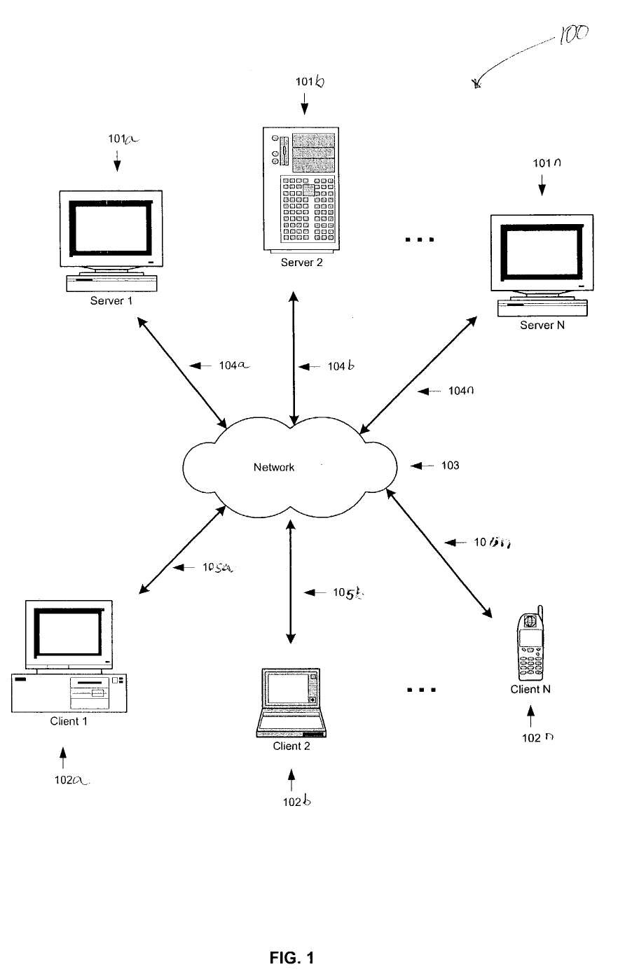

An Exemplary Environment—FIG. 1

FIG. 1 illustrates an exemplary environment 100 for implementing the inventions. The environment may include one or more servers 101a-n, one or more clients 102a-n, and a network 103 connecting the servers 101a-n and the clients 102a-n (as well as other devices (not illustrated)). The servers 101a-n are connected, respectively, via links 104a-n to the network 103, and the network 103 is connected, respectively, via links 105a-n to the clients 102a-n.

The methods and systems according to the inventions contemplate the interaction of one or more servers and one or more clients within a client-server network. The client-server network may refer to a hardware configuration, to a software configuration, or to a combination thereof. Any device or program may be capable of acting as a client and/or a server depending on the role the device or program plays based on the nature of the connection between the device or program and other elements. In other words, rather than a specific type of device or program, the terms “client” and “server” refer to the role a device or program performs during a specific connection or communication with another device, program, or element.

Typically, a server is a device or program that is a repository and distributor of information including data, application programs, etc. A client generally is a device or a program that requests and uses information from a server. A server may include one or more devices or programs, each of which is capable of serving one or more clients. The clients served by a server may be heterogeneous. As illustrated in FIG. 1, a client may be computer 102a, a laptop computer 102b, a wireless unit (such as a cellular telephone) 102n, a personal digital assistant (PDA) (not illustrated), a pager (not illustrated), or the like.

A server may run a protocol to accept connections and communications from a client. A server may run an agent that determines which, if any, software units are to be sent to a client. A software unit may be application software, or the like. A client may run an agent to communicate with the server, a loader to load and run the software units, and a linker to link software units together.

Application software is a set of instructions for use by a computer to carry out a specific job, such as word processing, accounting, spreadsheet, games, etc. Application software also may be referred to as an application program, an application, software, program, software unit, computer software, or computer program. Instructions that may be added to the application software as part of the claimed inventions are also referred to as code or programming.

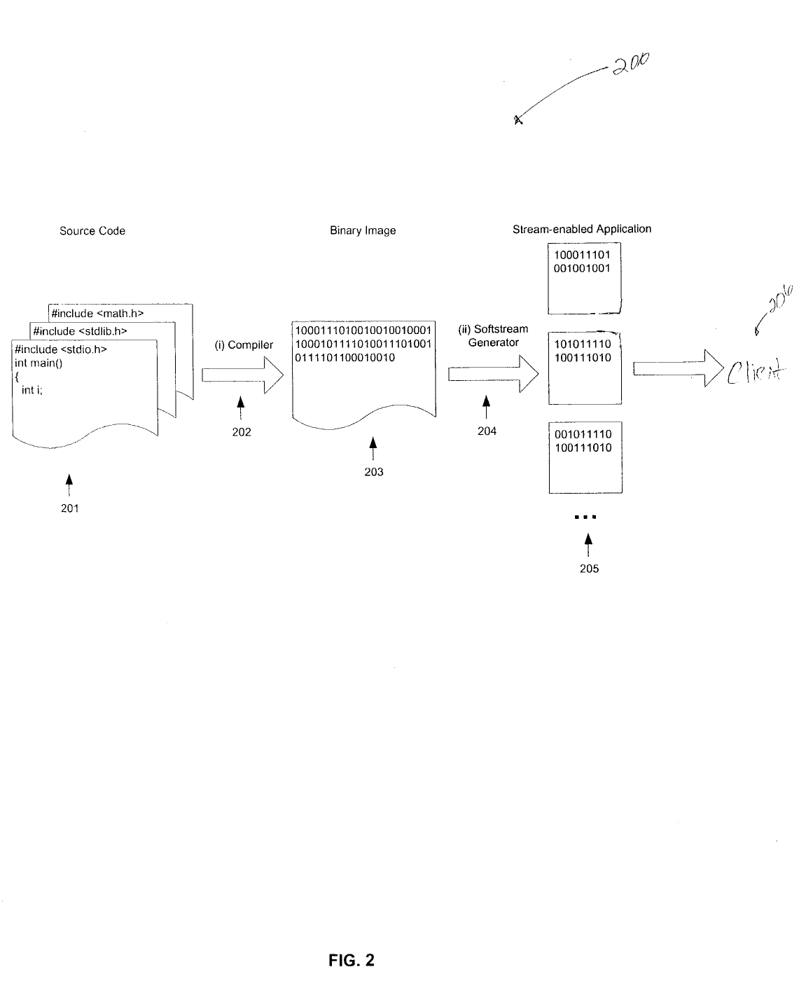

Exemplary Block Streaming—FIGS. 2-6

Block streaming of application software is an exemplary embodiment of the inventions. Advantageously, block streaming minimizes the time it takes to begin running or using application software downloaded from a server to a client by allowing the client to begin execution of the application software prior to completion of the download of the application software from the server.

An example of block streaming is now described. FIG. 2 illustrates an overview of elements and actions 200 that may take place at a server in connection with the exemplary block streaming. Generally, at a server, the source code 201 of the application software is compiled by a compiler 202 into an executable binary image 203. A generator 204 (also referred to as a softstream generator) divides the executable binary image 203 into blocks referred to in FIG. 2 as the stream-enabled application 205. The generator 204 may add code to the blocks as may be required and as discussed below. The server then transmits the stream-enabled application 205 to a client 206. The blocks (i.e., the stream-enabled application 205) may be transmitted in the background, on demand, or otherwise. Advantageously, the blocks may be transmitted in a particular sequence as requested by the client, as set by default, as set by the user, as set by the server, or otherwise.

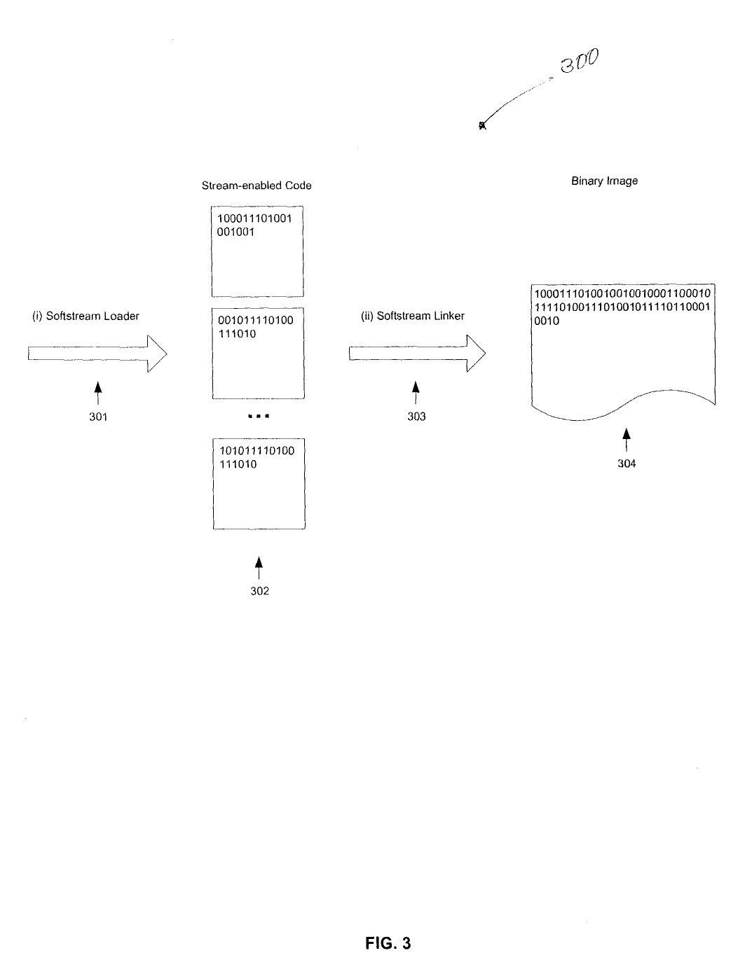

FIG. 3 illustrates an overview of elements and actions 300 that may take place at a client in connection with the exemplary block streaming. A loader 301 loads the blocks 302 (also referred to as stream-enabled code) into memory (not illustrated) of the client. A linker 303 (also referred to as a softstream linker) links the blocks 302 with the other information in the memory of the client 304.

Advantageously, once the client begins receiving the blocks, the client may begin executing the application software. The client does not have to wait for the complete download of the application software or even have to have all of the application software downloaded. By being able to begin execution of the application software prior to its complete download, the client presents the user with the application software more quickly than having to wait for the complete download.

Further details regarding an exemplary embodiment of block streaming of application software are now described.

As noted in the overview above, the source code of the application software is compiled into an executable binary image, which, in turn, is divided into blocks. Code may be added to the blocks prior to transmission to the client. The blocks (including modifications by addition of programming or code, if any) are also referred to as the stream-enabled application, stream-enabled application software, stream-enabled software, or stream-enabled code. The generation of this stream-enabled code may be carried out statically or dynamically.

Static stream-enabled code generation may be performed before the application software is requested by the user. Generating the stream-enabled code statically does not contribute to load-time overhead, once created, since the stream-enabled software is always ready to be transmitted. On the other hand, dynamic stream-enabled code generation may be done while the application software is being streamed. The dynamic generation of stream-enabled code may add some overhead. In dynamic stream-enabled code generation, however, the stream can be more adaptive to environmental conditions such as network congestion as the generator modifies off-block branch instructions and creates corresponding information for the client's loader.

In order to send and receive blocks between a server and a client, basic information regarding the stream-enabled application software may be created by the server and sent to the client. This basic information is referred to as stream-enabled application information. In the exemplary embodiment, the stream-enabled application information includes:

Application identifier (ID)—An integer assigned by the server for uniquely identifying the streaming session (i.e., the transmission of the blocks to the client);

Application Size—Indicates the size in bytes of the original application software.

Stream-enabled Data Size—Indicates the size in bytes of the code added to the application software for the streaming session.

Block Placement Type—One of two values: zero or one. The value of “0” informs the client's loader that the blocks of the application software must be placed in contiguous locations in memory. The value of “1” allows the client's loader to dynamically load blocks of the application software to any location.

Maximum Number of Blocks—The upper bound on the number of blocks to be transmitted to the client. This number is the same as the actual number of blocks if the stream-enabled software is generated prior to the request for streaming.

In the exemplary embodiment, at the beginning of a streaming session, the server transmits the stream-enabled application information to the client. The client uses the stream-enabled application information to set up the streaming session.

In particular, the client uses the stream-enabled application information to set up a block look-up table including an entry for each block of the application software. Each entry includes an identifier for a block and an address of that block in the client's memory. Not all blocks of the application software are necessarily in the client's memory. The exemplary embodiment uses a “−1” in the address field of an entry corresponding to a block that is not in the client's memory.

As noted, in the exemplary embodiment, at the server, the application software is divided into blocks by the generator. In addition, for each block, the generator generates an identifier, loader data, and linker data. The loader data includes the offset of the stream-enabled code and the stream-enabled code. The linker data provides the client's linker with information to handle block misses and to link blocks together. Each block is encapsulated prior to transmission.

In the exemplary embodiment, a block is transmitted in packet format including a 32 bit header for each of the block ID, the linker data size, and the loader data size. The payload contains the linker data and the loader data. The blocks of the application software may be transmitted in an arbitrary order. Alternatively, the blocks may be transmitted based on size or other features or functions included in the blocks. Further, the blocks may be transmitted in a particular sequence as requested by the client, as set by default, as set by the user, as set by the server, or otherwise.

In the exemplary embodiment, in response to receipt of the first block of the stream-enabled application, the client uses its loader (also referred to as softstream loader) to load the block to the allocated memory. In addition, the address of the block may be stored in the block look-up table referenced previously.

A block may be a contiguous address space of data or executable code or both. A block does not necessarily have a well-defined interface. For example, a block may not have a function call associated with the beginning and ending addresses of the block, but instead block boundaries may place assembly code for a particular function into multiple, separate blocks.

The size of each of the blocks of the application software may vary from application software to application software. Further, the size of each block in a group of blocks relating to the same application software may be different. Block size may be optimized for a particular application software or use by considering a number of factors.

One of the factors that may affect block size is the overhead that is added in connection with the use of the blocks. As explained below, code may be added to a block as part of the implementation of the inventions. Added code increases transmission and memory overhead. Larger block size may require less code to be added. Thus, increasing the block size may reduce the overhead that is added through the use of the inventions.

Another factor that may affect block size is application load time. The smaller the block, the faster it is transmitted and loaded at the client, and the faster the client can begin execution of the application software.

Yet another factor that may affect block size is application suspension time. When the client encounters a missing block in the execution of the application software, the client must wait for the missing block to be transmitted and loaded. The client's wait is referred to as application suspension time, wait time, or application load time. The smaller the missing block, the faster it is transmitted and loaded at the client, and the shorter the application suspension time. A short suspension time is critical to application software that involves many user interactions. While the application software is suspended, there is no user interaction.

By dividing the application software into blocks, transmitting the blocks to the client, and allowing the client to begin executing the application software without downloading all of the blocks, a problem may arise. The problem may be that the client does not have all of the necessary information to properly execute the application software. The client may be missing one or more blocks or a part or parts of one or more blocks.

More particularly, a block may include a part of application software that references another part or parts of the application software, but that is or are not included in the block. A reference to a part of application software that is not included in the block is called an “off-block instruction” or an “off-block branch”. In other words, when the client executes the application software by using a block, the client may encounter a reference to a different part or instruction of the application software that is not included in the block. The client encounters an off-block instruction.

The off-block instruction may cause a direct jump to a certain location in a different block. For example, the off-block instruction may direct the client to a block of the application software that is in the memory of the client. If so, then the client proceeds with executing the application software by reference to that block. A problem arises if the client encounters an off-block instruction such as a reference in a block to a part of the application software that is not in a block in the memory of the client. The client cannot follow the off-block instruction because the client does not contain the block referred to.

Advantageously, the exemplary embodiment solves the problem of the missing information by providing that code to be added to a block including off-block instructions. The code may be added at the server prior to transmission of a block to the client.

In an exemplary embodiment, after dividing the executable binary image of the application software into blocks, a determination is made as to whether a block includes an off-block instruction. If a block includes an off-block instruction, then code may be added to the block in the form of a block loader function. Alternatively, the off-block instruction may be modified to invoke a block loader function.

When the client encounters the block loader function, the client requests the server for the block that the client is missing. The server transmits the missing block, and the client continues executing the application software by using the missing block. Execution of the application software may be directed to jump to the appropriate place in the block that has been transmitted to the client. In addition, the client may modify the block (such as by modifying the off-block instruction) to include an instruction or a direction to the address of the missing block as it has been stored in memory of the client after transmission from the server.

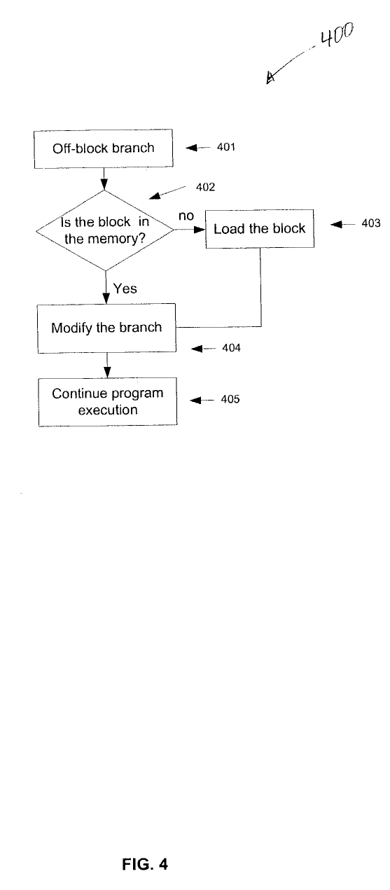

FIG. 4 illustrates the logic 400 that may be followed by a client when it encounters an off-block instruction (also referred to as an off-block branch). After the action 401 of encountering the off-block branch, the client checks in action 402 whether the block referred to in the off-block branch is in the memory of the client. If the referred to block is not in memory, then in action 403 the referred to block is loaded into memory such as by the client's invocation of its softstream loader and the loader's actions in requesting the server for the referred to block and receiving the referred to block. In action 404, the client modifies the off-block branch to include a direction to the recently loaded referred to block.

Referring again to action 402 of FIG. 4, the client may find the referred to block is in the client's memory. In that case, in action 404 the client modifies the block such as by modifying the off-block instruction to include a direction or instruction to the referred to block in the client's memory. After the modification action 404, the client continues its execution of the application software (also referred to as program) 405.

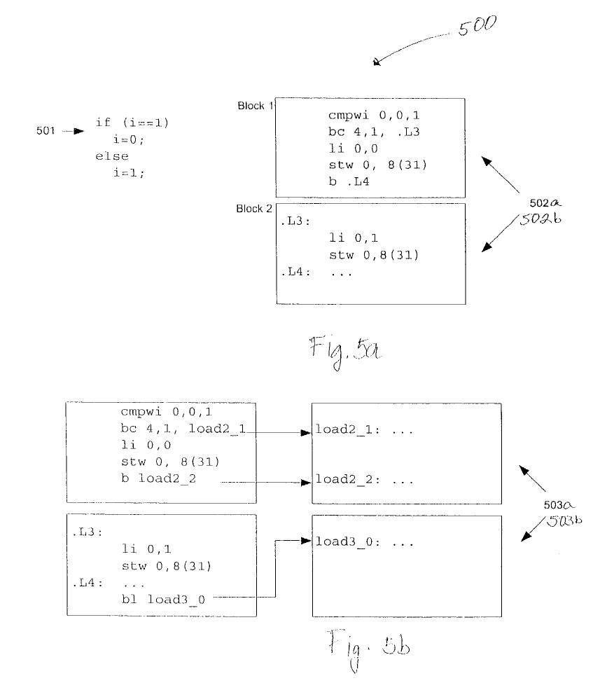

FIGS. 5a-5b are referenced in describing an example 500 of adding code to a block such as by adding code to an off-block instruction in the block which also may be referred to as modification of an off-block instruction in the block. Referring to FIG. 5a, a C statement 501 is compiled into two blocks 502a, 502b. The first block 502a (Block 1) contains two off-block instructions: bc 4,1, .L3; and b .L4. Both of these off-block instructions direct the client to the second block 502b (Block 2). The client may encounter a problem in executing the application software if: the client is using Block 1; encounters the off-block instructions; and Block 2 is not in the client's memory.

To avoid the problem of an off-block instruction that leads to a block not in the client's memory, the exemplary embodiment modifies or adds to off-block instructions in a block prior to transmission of the block to the client. In particular, an off-block instruction is modified or added to so as to include code to invoke the appropriate block loader function. When the client encounters the block loader function in using the block, the client is prompted to request the appropriate block from the server, load the block, and continue execution of the application software using the newly loaded block. Particularly, the added code may direct a jump to the appropriate place in a block to be loaded to the client.

Referring again to FIG. 5a, the exemplary embodiment determines Block 1 includes two off-block instructions. Off-block instructions bc 4,1, .L3 and b .L4, as seen in FIG. 5a, are added to or modified to bc 4,1, load2_{—}1 and b load2_{—}2, respectively, 503a, 503b as shown in FIG. 5b. so as to invoke the Block 2 502b.

Once the client loads the block referenced by the block loader function, the client may proceed with execution of the application software. If the client, however, again encounters the same block loader function, the client may be delayed in its execution of the application software by unnecessarily checking whether the appropriate block is in memory, or even by unnecessarily requesting and downloading the appropriate block from the server. To avoid this delay, the exemplary embodiment advantageously changes a block loader function in a block when the block referenced in the block loader function has been loaded into the client's memory. The block loader function is changed to include an instruction or direction to the newly loaded block.

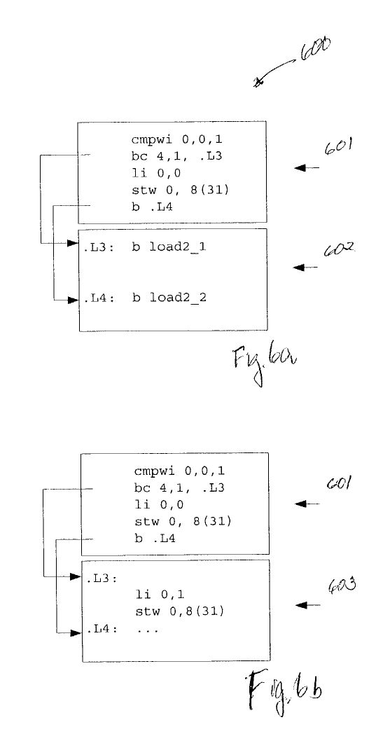

FIGS. 6a-6b illustrate an example 600 of changes to a block to include the instruction or direction to the newly loaded block. The off-block instructions in Block 1 from FIG. 5a (referenced as 601 in FIG. 6a) are changed to block loader functions as indicated by block 602 in FIG. 6a prior to transmission of Block 1 to the client. As indicated in FIG. 6b, once the client encounters the block loader functions and loads the appropriate block(s), then as illustrated by block 603 the block loader functions are changed to instructions or directions to the appropriate newly loaded block(s).

A disadvantage to the changing of a block loader function after its referenced block has been loaded into memory is that the additional code needed to effect such changes adds overhead. An advantage gained, however, from changing a block loader function to an instruction or direction to the appropriate newly loaded block is a more efficient, smoother running of the application software. Without changing the block loader function to the instruction with direction, the client repeatedly encounters the block loader function when it executes the block of the application software. Each time, the client must check whether the missing block is in memory, and if it is not in memory, then the missing block must be transmitted to the client from the server.

If, on the other hand, the check reveals that the block is not “missing”, but is in memory, then the check is unnecessary and adds to wait time. The repeated checks carried out by the client add to the incidents of suspension time of the application software. If the block loader function is changed to the instruction or direction to the newly loaded block, the application software executes more efficiently and smoothly because the client does not have to carry out the checks described above.

There is another problem that may arise with the division of application software into blocks. The application software may be divided so that the last instruction in a block is not a branch or a return instruction. In that case, the client proceeds to the next block for instructions. There may not be, however, a next block in the client's memory. The lack of the next block in the client's memory may cause a problem for the client in the execution of the application software.

To solve the problem, the exemplary embodiment causes a block to include a block loader function as the last instruction in the block. By the inclusion of a block loader function as the last instruction in a block, the client does not encounter the problem of a missing “next” block. The client encounters the block loader function and loads the appropriate block for its next instruction in executing the application software.

For example, as shown in FIG. 5a, the application software is configured into blocks so that the last instruction in Block 2 is not a return or branch instruction. The client ordinarily proceeds in execution of the application software from Block 2 to Block 3 (not illustrated) on the basis of the lack of a return or branch instruction. If the client does not have Block 3 in memory, then the client encounters a problem in the execution of the application software.

To solve the problem, the exemplary embodiment modifies the application software to include a block loader function as the last instruction of Block 2. FIG. 5b illustrates that the block loader function of b1 load 3_0 has been appended as the last instruction in Block 2. When the client encounters the block loader function, the client requests the designated block to be transmitted from the server to the client. The client loads and uses the block to continue execution of the application software. After the client has loaded the block, the block loader function in Block 2 may be changed to include an instruction with direction to the newly loaded block for further instructions.

Exemplary Stream-Enabled File Input/Output

Block streaming may be used in the transmission of data files as well as the transmission of application software. Block streaming used with data files also may be referred to as stream-enabled file input/output (I/O). Advantageously, the block streaming of data files results in the client being able to use the data before all of it is downloaded from the server.

To block stream a data file, it is divided into blocks (also referred to as data blocks). The data blocks are transmitted to the client. The data blocks are preferably transmitted in the order in which the data in the block is used.

At the client, a file status table is created. Each entry in the file status table relates to a data block, and each entry includes a valid field and an address field. The valid field provides information on whether the corresponding data block is available at the client. The address field stores the location of the corresponding data block.

A file status table may be consulted by the client when it encounters a need for data from the data files. A stream-enabled file I/O function call uses the file status table to determine whether or not a desired data block is available at the client. If the desired data block is missing, then it may be obtained from the server. Once all of the data blocks are downloaded to the client, the stream-enabled I/O function calls may be replaced with more efficient system calls.

Block streaming of data files may also be used in a situation where only the minimum of necessary data files are downloaded in blocks to the client. Such a situation may be presented by devices having limited storage. When a data block not in storage at the client is needed, then the data block is downloaded from the server. Further, a data block that is stored at the client, but is not being used or otherwise needed may be returned to the server so as to minimize the data blocks being stored at the client. If the data block is later needed, then it may be downloaded from the client to the server.

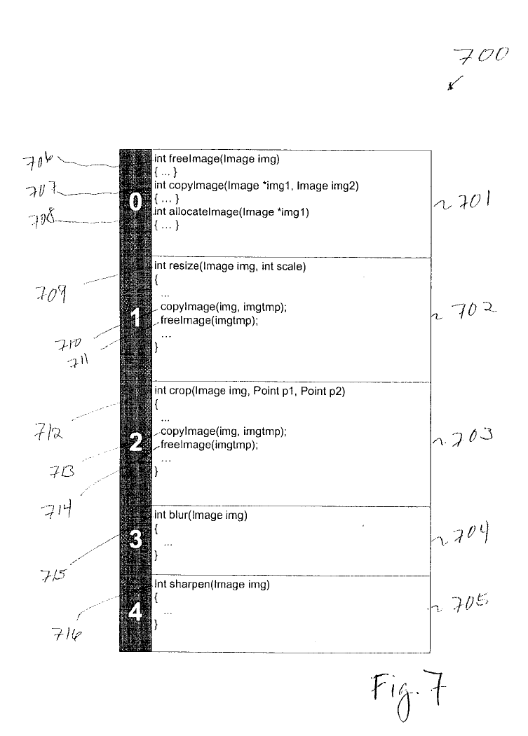

Exemplary Component Streaming—FIGS. 7-9

Component streaming of application software is an exemplary embodiment of the inventions. Advantageously, component streaming minimizes the time it takes to begin running or using application software downloaded from a server to a client by allowing the client to begin execution of the application software prior to completion of the download of the application software from the server.

An example of component streaming is now described. As the term “component streaming” implies, the application software to be streamed is divided into components. A component may include data and/or instructions. Each component includes well-defined interfaces including support for streaming. An interface may also be referred to as a function call or a method. Interfacing with a component is accomplished by using the well-defined interfaces associated with the component such as by using its function calls or methods.

In the exemplary embodiment, each component is encapsulated by a corresponding component stream-enabling handler. A component stream-enabling handler includes code or programming which requests the component to be streamed if the component is unavailable at the client such as when the component is necessary for execution of the application software. The component stream-enabling handler is preferably linked to the component of the application software at compile time. A component stream-enabling handler may be generated from a configuration file associated with the application software. The configuration file is useful for generation of the component stream-enabling handler because the configuration file typically contains component information such as function names and filenames.

As noted, application software may be divided into components. The division of the application software into components may vary from application software to application software. Further, the size or inclusion of information in each component of component constituting application software may be different. Component size and/or contents may be optimized for a particular application software or by considering a number of factors. The factors taken into account with respect to component size and/or contents are similar to the factors taken into account when dividing application software into blocks as explained above.

Generally, a component includes one or more functions that is or are carried out by the application software in its execution. A problem may arise with a component's inclusion of more than one function. Assume the component has not been downloaded to the client. In the execution of the application software, the client may need only one function from the group of functions included in the component. The problem is that the client has to download the complete component so as to have access to the one function that the client needs. This problem may cause application suspension time.

Advantageously, the exemplary embodiment solves the problem of having to download the complete component by dividing the component into sub-components. Further, the exemplary embodiment may transmit only the minimum necessary of the sub-components. A sub-component may include data and/or one or more functions of the application software. The division of a component into sub-components also may be based on a number of factors such as the factors used in dividing application software into components or blocks as discussed above.

The solution of dividing a component into sub-components creates its own problem. The problem is that a function in a sub-component may depend on one or more functions in other sub-components. In other words, a function in a sub-component may need another function or functions not in the sub-component for the function in the sub-component to operate properly. For convenience herein, a function in a sub-component that depends on another function or functions in a different sub-component is referred to as a dependent function.

The exemplary embodiment solves the problem of dependent functions. In sum, the exemplary embodiment requires all functions upon which a function is dependent as well as the function to be downloaded prior to the client being able to use the needed function. An example of the exemplary embodiment's solution to the problem of dependent functions is described below.

FIG. 7 illustrates a component 700 having five sub-components 701705. Sub-component 701 includes three functions: int freeImage 706; int copyimage 707; and int allocateImage 708. Sub-component 702 includes a function: int resize 709, which depends on two functions from sub-component 701 as indicated by the sub-component's references to copyimage 710 and freeImage 711. Sub-component 703 includes a function int crop 712, which depends on the same two functions from sub-component 701 as indicated by the sub-component's references to copyimage 713, and freeImage 714. Subcomponent 704 includes a function int blur 715. Sub-component 705 includes a function Int sharpen 716.

In this example, a function in each of the sub-components 702 and 703 is dependent on functions in sub-component 701. In other words, a function in each of the sub-components 702 and 703 requires the features of functions found in sub-component 701. Referring to FIG. 7 again, the int resize 709 function of sub-component 702 is a dependent function. The int crop 712 function of sub-component 703 also is a dependent function.

The dependence of a function in a sub-component on a function or functions in another sub-component affects the time at which the client may begin execution of the dependent function of the application program. In the exemplary embodiment, the client cannot begin execution of a dependent function until all of the functions upon which the dependent function is dependent and the function are loaded in the client's memory.

In the example referring to FIG. 7, the init resize function 709 of sub-component 702 is a dependent function. Thus, the client cannot begin execution of the int resize function 709 until the functions of int freeImage 706 and int copyimage 707 as well as int resize function 709 are loaded in the client's memory.

Advantageously, in the exemplary embodiments, in response to the issues of function dependence, the server transmits sub-components to the client based on such function dependence. A sub-component with a function that is depended upon by a function in another sub-component is transmitted prior to the sub-component including the dependent function. The order of transmission of sub-components based on function dependence allows the client to more quickly begin executing the application software. The client can begin executing the application software using the function or functions that do not depend on other functions.

Referring again to the example of FIG. 7, the server transmits sub-component 701 to the client prior to transmitting either sub-component 702 or 703. Sub-component 701 is transmitted prior to sub-component 702 or 703 because sub-components 702 and 703 include respective functions dependent on functions in sub-component 701. Advantageously, the client can begin execution of the functions in sub-component 701 upon receipt of that sub-component 701 because it does not have functions dependent on other functions. Thus, by first sending a sub-component having functions which the client may begin executing upon receipt, and then sending sub-components with dependent functions, the exemplary embodiment allows the client to begin execution of the application software prior to the complete download of all of the sub-components.

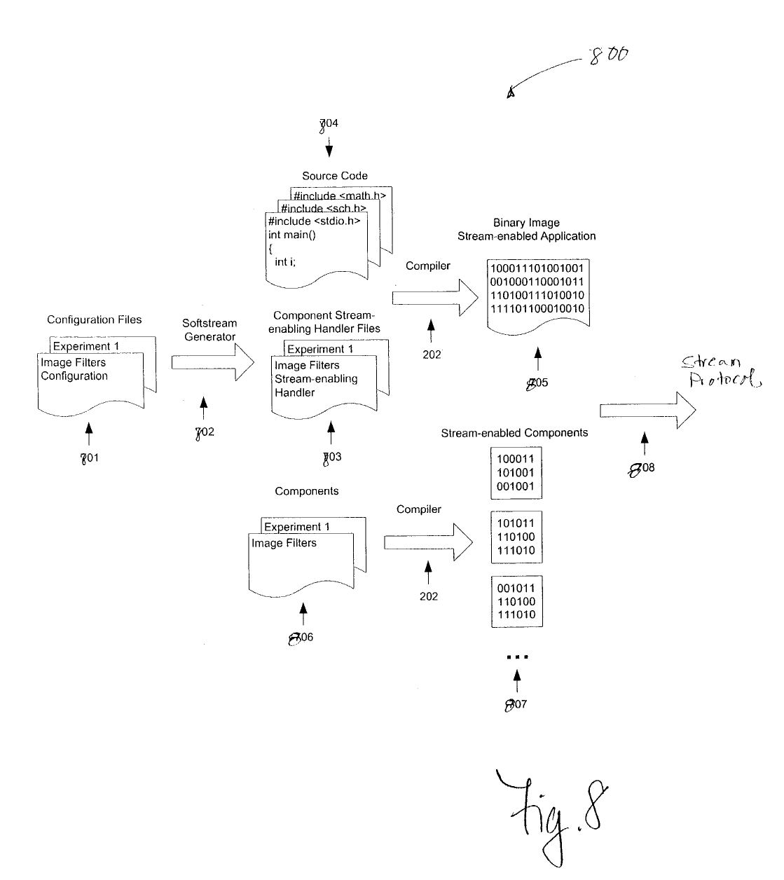

FIG. 8 illustrates an overview of elements and actions 800 that may take place at a server in connection with the exemplary embodiment of component streaming. In component streaming, at the server, configuration files 801 of the application software are used by a generator 802 (also referred to as a softstream generator) to generate component stream-enabling handler files 803 (also referred to as component wrapper files).

The component stream-enabling handler files 803 and the source code 804 of the application software are used by the compiler 202 to generate a binary image stream-enabled application software 805. The binary image stream-enabled application software is sorted into components 806.

The components 806 are used by the compiler 202 to compile the stream-enabled components 807. The binary image stream-enabled application 805 and the stream-enabled components 807 reside at the server until they are transmitted as a stream protocol 808.

Advantageously, the exemplary embodiment of component streaming minimizes the client's effort in locating and obtaining functions by keeping a table of locations. The table is called the component interface table. Each entry in the table includes: an identification of a function; and an address for the function in the client's memory. If a function is not in the client's memory, then the address field includes an address for a locator function for requesting the component or sub-component containing the function to be transmitted from the server to the client.

If a needed function is not in the client's memory, then the locator function from the appropriate entry in the component interface table is used to cause the server to transmit the component or sub-component including the function to the client. As explained above, in some cases, a needed function is a dependent function and additional functions have to be transmitted to the client in order for the needed function to be usable in executing the application software.

Once the function or functions are stored in the client's memory, then the address of each of the functions is updated in the component interface table. The updating of the component interface table with the location of the function in the client's memory streamlines the client's process for later obtaining the function. Subsequent calls for that function are directed to the component or sub-component including the function as stored in the client's memory. By the update of the component interface table, the client is able to skip the actions of calling the locator function for the function and having the component or sub-component including the function downloaded from the server. Advantageously, component checking overheads are eliminated once the component is loaded at the client and the component interface table is updated.

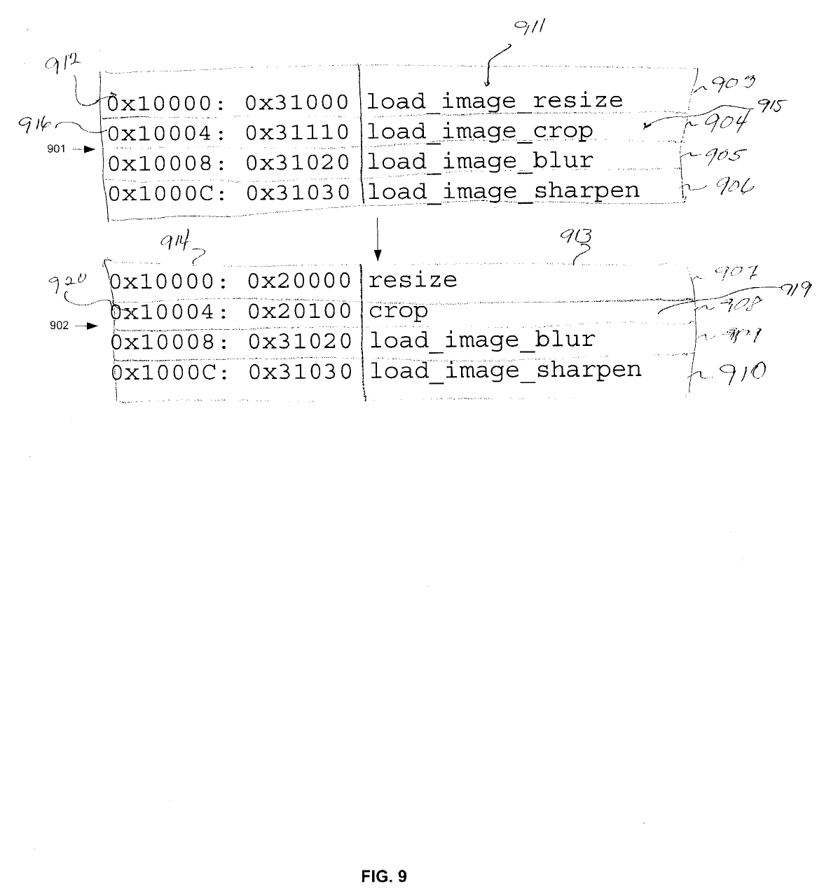

FIG. 9 illustrates an example of updating a component interface table. Table 901 includes four entries 903-906 relating to four respective functions. In this example, none of the functions are initially stored in the client's memory. Thus, each entry 903-906 includes a locator function for requesting the component or sub-component containing the function to be transmitted.

Table 902 of FIG. 9 is an updated version of Table 901. Table 902 includes four entries 907-910 corresponding respectively to entries 903-906 in Table 901. Two entries 907, 908 in Table 902 have been updated to reflect the loading of their respective functions in the client's memory. In particular, Table 901 includes an entry 903 with a locator function 911 “load_image_resize” for the resize function and with an address 912 for the locator function. After the resize function has been loaded into the client's memory, the updated entry 907 in Table 902 includes the function identification 913 “resize” and its address 914 in the client's memory.

Similarly, Table 901 includes an entry 904 with a locator function 915 “load_image_crop” for the crop function and with an address 916 for the locator function. After the crop function has been loaded into the client's memory, the updated entry 908 in Table 902 includes the function identification 919 “crop” and its address 920 in the client's memory.

Real-Time Applications Having a Non-Interruptible Section

As noted, the stream-enabled code transmitted from the server to the client may be divided into blocks or components. In some cases, such as to save memory, not all the blocks or components of application software are transmitted to the client. In some cases, however, care must be taken to transmit the appropriate blocks or components for proper performance of the application software at the client.

For example, some real-time applications may contain a non-interruptible section. This means that while the processor is executing the non-interruptible section, the processor cannot accept interrupts. Usually, a non-interruptible section contains instruction(s) to disable interrupts and one or more instructions to enable interrupts. A real-time code section should not be suspended due to missing software components because downloading software from the network can be very long and unpredictable. Therefore, a non-interruptible real-time section must be put in a single block or component.

Background Streaming

As noted above, block streaming and component streaming allow a client to begin using application software without having to have all of the application software completely downloaded to the client. In some cases, parts of the application software are not downloaded from the server until they are requested by the client. In some other cases, it is preferable that interruptions in the running of the application software are avoided. Block streaming and component streaming still may be used in those cases where interruptions are preferably avoided.

Block streaming and component streaming of application software may be conducted as background streaming so as to avoid interruptions in the running of the application software. Background streaming transmits all of the blocks or components of the application software. Further, the application software is transmitted without modification. By allowing the blocks or components to be transmitted in the background while the application software is running, the programming needed by the client may be stored in the client's memory by the time the need arises.

In sum, by using background streaming, the client may begin use of application software prior to complete download of the application software. Yet, interruptions to the running of the application software resulting from missing code are minimized due to the transmission of all of the application software and its transmission without modification.

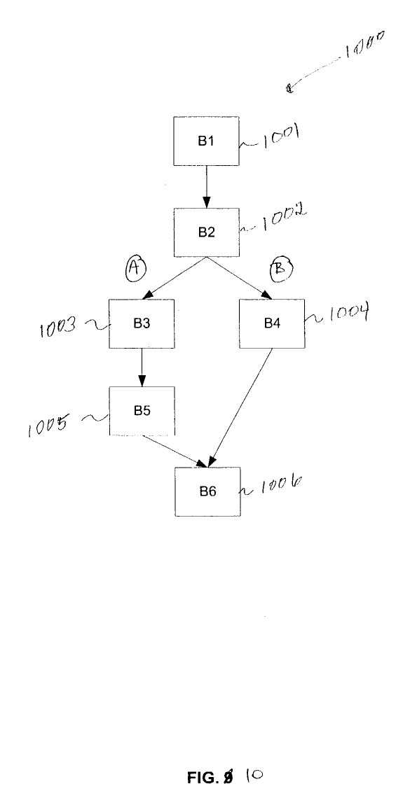

Software Profiling—FIG. 10

Software streaming lowers the load time of application software and provides the advantage of allowing a client to begin running application software prior to its complete download. Yet, software streaming can have the disadvantage of application suspension times due to missing elements of the application software at the client. When a needed block/component is unavailable at the client, the running of the application software must be suspended until the needed block/component is retrieved from the server and loaded.

Some real-time applications tolerate few, if any, application suspension times. The unpredictability of application suspension times may lead users of real-time application software to avoid software streaming. Some predictability can be achieved and application suspension times minimized through the use of software profiling in connection with software streaming.

Software profiling can be used to alleviate the problem of application suspension times in software streaming. Based on the execution of the application software, software profiling determines the order in which the blocks/components of the application software are to be streamed, which blocks/components are to be background streamed, and which blocks/components may be held at the server and only streamed to the client on demand. Software streaming then may be conducted based on the software profiling. As a result, delays in execution of the application software due to missing programming at the client are minimized.

In sum, software profiling determines which blocks/components are necessary to branches or parts of application software. Based on the client's execution of a branch or part of application software, the necessary blocks/components are streamed to the client so as to minimize application suspension times due to missing programming. If the client changes execution to another branch or part of the application software, then software profiling may provide information on how to change the order or kind of streaming of the blocks/components to the client.

For example, the order of execution of application software may be viewed as a control/data flow graph 1000 as illustrated in FIG. 10. In this example, the client may use block B1 1001 and block B2 1002 in executing application software. After block B2 1002, the client may follow branch A or branch B to reach block 6 1006. If the client follows branch A, then it uses block B3 1003 and block B5 1005 to reach block 6 1006. If the client follows branch B, then it uses block B4 to reach block 6 1006.

Applying software profiling to the example illustrated in FIG. 10, if the client begins execution of branch A by using block B3 1003, then the server can background stream block B5 1005 and block B6 1006 to the client. It is unnecessary to stream block B4 because it is not used in the execution of branch A. Blocks/components that are unnecessary to the execution of branch A are not streamed to the client, or at least, are streamed only after other blocks/components are streamed.

### CONCLUSION

The inventions include methods and systems of software streaming including block streaming and component streaming that allow a client to begin execution of application software prior to all of the application software being downloaded to the client. Thus, the inventions allow a client to more quickly begin execution of application software than where all of the application software has to be downloaded prior to the start of execution. In addition, the inventions minimize application suspension time during the execution of the application software. A minimization of application suspension time improves the interaction between client and user because the execution of the application software appears to be more efficient and smooth in operation.

From the foregoing description of the exemplary embodiments of the inventions and operation thereof, other embodiments will suggest themselves to those skilled in the art. Therefore, the scope of the inventions is to be limited only by the claims below and equivalents thereof.

We claim:

1. A method for minimization of application load time of application software, the method comprising:
dividing the application software into blocks;
finding that execution of a block requires an instruction not included in the block;
modifying the block to include a block loader function for calling a block that includes the instruction;
transmitting at least one of the blocks to a device for starting execution of the application software;
starting the execution of the application software by using one or more of the transmitted blocks;
in response to using the block with the block loader function in the execution of the application software, causing transmission of the block that includes the instruction to the device executing the application software; and
executing the application software using the instruction.

2. The method of claim 1, wherein the application software comprises stream-enabled application information including an application size, a stream-enabled data size, a block placement type, and a maximum number of blocks.

3. The method of claim 1, further comprising causing the device to set up a block-lookup table having an entry corresponding, respectively, to the transmitted blocks with each entry including an identifier of a block and an address for the block.

4. The method of claim 1, further comprising:
after transmission of the block that includes the instruction, changing the block loader function in the block into a direction to the block that includes the instruction.

5. The method of claim 1, wherein starting execution of the application software by using one or more of the transmitted blocks comprises starting the execution of the application software by using one or more of the transmitted blocks even though all of the blocks of the application software have not been transmitted to the device executing the application software.

6. A method for minimizing the time it takes to start running application software by allowing a client to begin executing the application software prior to completion of download of the application software from a server, the method comprising:
dividing the application software into blocks;
determining a block includes an off-block instruction;
modifying the off-block instruction to include a block loader function.
transmitting one or more of the blocks from the server to the client; and
in response to receiving the one or more blocks, causing the client to load and link each block in memory; and
causing the client to begin executing the application software by using the one or more of the blocks even though not all of the blocks of the application software have been transmitted from the server to the client.

7. The method of claim 6, wherein the off-block instruction directs the client to a specific block not in the memory; and
wherein the block loader function causes transmission of the specific block from the server to the client.

8. The method of claim 7, wherein the transmission of the specific block from the server to the client causes modification of the off-block instruction to an address of the specific block.

9. The method of claim 6, wherein dividing the application software into blocks comprises assigning stream-enabled application information to the application software.

10. The method of claim 9, wherein the stream-enabled application information comprises: an application size, a stream-enabled data size, a block placement type, and a maximum number of blocks.

11. The method of claim 9, wherein transmitting the one or more blocks from the server to the client comprises causing the server to first transmit the stream-enabled application information.

12. The method of claim 11, wherein, in response to receiving the one or more blocks, the client is caused
to receive the stream-enabled application information, and
to set up a block-lookup table having entries corresponding, respectively, to each of the one or more blocks with each entry including an identifier and an address.

13. The method of claim 6, wherein dividing the application software into blocks comprises assigning respectively linker data and loader data to each block; and
wherein the client is caused to use the linker data and the loader data in loading and linking the one or more blocks into the memory.

14. The method of claim 6, wherein the off-block instruction included in the block corresponds to a specific block.

15. The method of claim 14, further comprising:
causing the client, in encountering the off-block instruction while executing the application software, to determine that the specific block that corresponds to the off-block instruction is in the memory; and
changing the off-block instruction to include a direction to the specific block.

16. The method of claim 14, further comprising:
causing the client, in encountering the off-block instruction while using the application software, to determine that the specific block corresponding to the off-block instruction is not in the memory; and
causing transmission of the specific block from the server to the client.

17. The method of claim 16, further comprising:
after receiving the specific block from the server, storing the specific block in the memory; and
changing the off-block instruction to include a direction to the specific block in the memory.

18. A method for minimization of application load time of application software, the method comprising:
dividing the application software into components with each component including an interface;
encapsulating each component by a corresponding component stream-enabling handler;
dividing a component at least into a first sub-component and a second component with the first sub-component including a first function and with the second sub-component including a second function, and with the first function being dependent upon the second function;
executing the application software and noting a need for the first function of the first sub-component of the component;
making a call for the first function of the first sub-component of the component by using an interface of the component and by using a component stream-enabling handler corresponding to the component;
in response to the call, determining the first function of the first sub-component depends on the second function of the second sub-component; and
transmitting the first sub-component and the second sub-component in response to the call.

19. The method of claim 18, wherein dividing the application software into components comprises linking the component stream-enabling handler to the component at compile time of the application software.

20. The method of claim 18, further comprising:
generating a component stream-enabling handler corresponding to each component of the application software from a configuration file associated with the application software.
